(19) United States
(12) Patent Application Publication
(10) Pub. No.: US 2024/0367452 A1
(43) Pub. Date: Nov. 7, 2024

(54) NON-POLAR THERMOPLASTIC COMPOSITE HAVING A DYE SUBLIMATION PRINTED IMAGE AND METHOD TO FORM THEM

(71) Applicant: GreenTech Composites LLC, Livingston, NJ (US)

(72) Inventors: Paul Palmer, Livingston, NJ (US); Anastasia Freitas, Livingston, NJ (US); Stephan Lerman, Livingston, NJ (US)

(21) Appl. No.: 18/689,210

(22) PCT Filed: Sep. 2, 2022
(86) PCT No.: PCT/US2022/042449

§ 371 Date: Mar. 5, 2024

Related U.S. Application Data
(60) Provisional application No. 63/241,621, filed on Sep. 8, 2021.

(51) Int. Cl. B41M 5/035; C08J 7/04; C08K 7/02

(52) U.S. Cl. CPC B41M 5/0355; C08J 7/042; C08K 7/02; C08J 2323/06; C08J 2475/02

(57) ABSTRACT

An article is comprised of a composite substrate comprising a non-polar thermoplastic polymer such as a polyolefin or polyvinyl chloride and a filler having polar groups, the composite having a dye sublimation image in a layer adhered or integral to a surface of the composite. The article may be made by exposing the aforementioned composite substrate to a temperature above 100° C., which is typically above the melt temperature of the non-polar thermoplastic polymer, to about 250° C. and pressing a dye sublimation film onto the composite substrate for a time to imprint the dye sublimation image into the accepting layer forming the article. The article may be used for applications having aesthetic or structural requirements in the construction arts such as railing, decking or fencing.

### FIELD

The invention relates to forming a composite comprised of a non-polar thermoplastic (e.g., polyolefin, polyvinyl chloride or polyvinylidene dichloride and filler having a dye sublimation printed image thereon. In particular, the invention relates to articles comprising a composite comprised of the non-polar thermoplastic and cellulosic filler having a dye sublimation image thereon.

### BACKGROUND

Over many years in the building construction industry there has been a continuing shift from the use of natural materials (e.g., wood) to metal and engineered wood products for structural applications. Likewise, there has been a similar trend to replace wood for use in functional and aesthetic applications such as siding, fences, deck planking, railing and balustrades exposed to the environment. For example, PVC (polyvinyl chloride) and fiber cement siding have become common. Likewise, decking and railing have become available such as those available under the tradename TREX, which are composite plastic materials coextruded with an embossed plastic cap layer. Even though the cap layer may be embossed and use variegated color, they tend to lack the realism desired.

More recently in the commercial building industry, coated metal panels having dye sublimation printed (DSP) images thereon have been used to form large panels for use in doors, windows and cladding such as described in U.S. Pat. Nos. 6,136,126 and 6,335,749. The DSP process, typically, requires elevated temperatures of ^{˜}170 to 200° C. and significant compressive forces, which have essentially precluded plastic substrates having DSP images thereon use in forming construction materials. Because of the expense of the process and material constraints, metal substrates having DSP images thereon have tended to be limited to commercial buildings with their longer life requirements.

It would be desirable to provide a cost effective, aesthetically appealing synthetic construction material that has improved properties, weathering, weight and comfort and method to produce such construction material.

### SUMMARY

Applicants have discovered that non-polar thermoplastic composites useful for decking may be rendered more aesthetically pleasing reflecting more natural wood construction materials. Non-polar thermoplastic polymer means a polymer that has no bonds having a Pauling electronegativity difference greater than 0.65 within the polymer. For example, polyvinyl chloride is comprised of C—C, C—H and C—Cl, bonds with the C—Cl bond having a difference in electronegativity of 0.61 (C=2.55 and Cl=3.16). In particular, it has been discovered that non-polar thermoplastic composites and in particular those formed from polyolefins (e.g., polyethylene, polypropylene and combinations thereof) and polyvinyl chloride or polyvinylidene dichloride (poly(1,1-dichloroethene) may be formed with a dye sublimated printed (DSP) image printed directly thereon or onto one or more layers formed on the composite to form a thermoplastic composite having thereon or attached thereto a DSP image. The DSP image, because it penetrates and diffuses into the composite or layer attached or adhered to the composite allows for the creation of a long-lasting wear surface that enables it to be aesthetically appealing even after long exposure to the environment and use. Surprisingly, the method may be performed at temperatures that may deform or distort the composite.

A first aspect of the invention is an article comprised of a composite substrate comprising a non-polar thermoplastic polymer and a filler having polar groups and having a dye sublimation image in a layer attached or integral to a surface of the composite. It has been surprisingly discovered that a thermoplastic polymer not capable of taking a sharp DSP image may be dye sublimation printed even at temperatures that normally would typically deform or distort the non-polar thermoplastic polymer when there is a sufficient amount of filler having polar groups enabling the adherence or integration of an image accepting layer directly onto the composite.

A second aspect of the invention is a method of forming an article having a dye sublimation image thereon comprising,
(i) exposing a composite substrate comprising a non-polar thermoplastic polymer, a filler having polar groups, and a dye sublimation accepting layer thereon to a temperature above 100° C. to about 250° C. and,
(ii) pressing a dye sublimation film onto the composite substrate for a time to imprint the dye sublimation image into the accepting layer forming the article. The melt temperature (Tₘ) is the peak temperature of the melt peak in a differential scanning calorimetry scan at 20° C./min as per ASTM D3418. Polar groups herein means any compound that displays difference in electronegativity above 0.65 to 2 between 2 atoms within the compound. Examples of non-polar groups or bonds include C—H, C—Cl and C—C bonding within the non-polar thermoplastic polymer. Examples of polar groups include carboxylic acid, hydroxyl, ester, and ether groups.

### DESCRIPTION OF THE DRAWING

FIG. 1 is an is cross-sectional illustration of an article of this invention.

### DETAILED DESCRIPTION

The explanations and illustrations presented herein are intended to acquaint others skilled in the art with the invention, its principles, and its practical application. The specific embodiments of the present disclosure as set forth are not intended to be exhaustive or limit the scope of the disclosure.

One or more as used herein means that at least one, or more than one, of the recited components may be used as disclosed. It is understood that the functionality of any ingredient or component may be an average functionality due to imperfections in raw materials, incomplete conversion of the reactants and formation of by-products.

The article is comprised of a composite comprised of a non-polar thermoplastic polymer and a filler therein having polar groups, the composite having a dye sublimation image an accepting layer attached or integral to a surface of the composite. The non-polar thermoplastic polymer may be any wherein the largest difference in Pauling electronegativity between two atoms in the polymer is at most about 0.65.

The non-polar thermoplastic polymer generally displays at least about 3% crystallinity to essentially fully crystalline when heating and cooled at rates commonly experienced when forming or compounding such polymers (e.g., heating and cooling rates from ambient temperature ^{˜}25° C. to the melting temperature). That is, the polymer displays crystallinity without forced crystallization methods such as those known in the art (e.g., solvent induced crystallization and the like). Generally, the amount of crystallinity is at least about 5%, 10%, 15% or 20% to about 95%, 75%, 50% or 30%. The crystallinity may be determined by any suitable methods such as those known in the art. Illustratively, the percent crystallinity may be determined by x-ray diffraction including, for example, wide angle x-ray diffraction (WAXD, or by differential scanning calorimetry (DSC), such as by using a commercially available differential scanning calorimeter per standard ASTM D3418-15. The non-polar thermoplastic polymer may be amorphous displaying a T_{g} (onset of deviation from linear during heating) as determined by DSC.

The non-polar thermoplastic may be a polyolefin. The polyolefin may be any suitable polyolefin such as those known in the art. Illustratively, the polyolefin may be comprised of one or more olefin monomers have 2 to 12, 8, 6 or 4 carbon atoms. Desirably, the polyolefin is comprised of one or more of polyethylene, polypropylene, or copolymer of ethylene and propylene. Desirably, the polyolefin is comprised of post-use polyolefins (e.g., shopping bags, milk bottles and the like) that have been recycled, heated and mixed with the filler to form the composite. Examples of suitable polyolefins include polyethylene, polypropylene or combinations thereof available from The Dow Chemical Company, Exxon, Total and the like.

The non-polar thermoplastic may be a polymer comprised of C, H, and Cl such as known chlorine containing polymers such as polyvinyl chloride (PVC) and polyvinylidene dichloride (PVDC) that are commercially available. The chlorine containing polymers may be post use polymers such as recycled piping and the like. Examples of commercially available chlorine containing polymers include but are not limited to PVC available from Shin-Etsu Co., Ltd., Japan, with the rigid grades being preferable and PVDC under the SARAN trademark from the Asahi Kasei, Japan.

The non-polar thermoplastic polymer may be any useful molecular weight for making the composite. Typically, the weight average molecular weight (Mw) of the non-polar thermoplastic polymer is from about 20,000; 50,000 or 75,000 to 1,000,000; 500,000 or 250,000 g/mole.

The thermoplastic may also be comprised of a further thermoplastic polymer such as those known in the art. Exemplary further thermoplastic polymers may include condensation polymers, addition polymers or grafted polyolefins having polar groups. Examples include polymers such as polyester, thermoplastic polyurethane, polyketone, polyethers, copolymers or grafted polymers of polyethylene or polypropylene grafted or copolymerized with addition polymerizable monomer having polar groups such as acrylics, acrylates or anhydrides. Generally, the composite is present without such further thermoplastic polymers, but when present the amount of such further thermoplastic polymers is typically less than about 50%, 30%, 20% to about 1% by weight of the total amount of thermoplastic polymers in the composite (i.e., balance is the non-polar thermoplastic polymer).

The composite is comprised of a filler to realize the desired mechanical properties and adhesion of the accepting layer 40 or abutment layer 30. The filler may also facilitate the composite's ability to withstand the conditions necessary to form the dye sublimation image. The filler may be any suitable for enhancing or realizing a desired properties such as stiffness, thermal conductivity, strength, heat resistance or the like. The filler may be any such as those known to be useful in organic polymers. Illustratively, the filler may be a metal, ceramic or other organic polymer (e.g., polymeric fiber such as an engineering plastic fiber having polar group). The filler may be an inorganic compound having polar groups (e.g., metal oxide particulates having polar surface groups). The filler may be particles, fibers, sheets or combination thereof. The sheets may be woven or unwoven fibrous fabrics or sheets. Desirably the filler is a chopped fiber, particle or combination thereof.

The fiber may be any useful fiber such as an inorganic glass fiber, engineering plastic fiber (e.g., polyamide, polyimide, polycarbonate, polypropylene or the like), carbon fiber, metal fiber or wire or combination thereof including for example organic polymer coated metal, carbon or inorganic glass fibers. The fibers may be long or chopped fibers. Long fibers generally meaning the fibers transverse a substantial distance of one or more dimensions of the composite or article (generally a long fiber is at least about 5 or 10 mm and chopped fibers are less than this length). Typically, the fiber or wire may have any useful cross-sectional shape such as square, rectangular, ovoid, spherical or other polygon shapes (e.g., hexagon, parallelogram, triangle and the like). Typically, the average diameter of the fiber is between 1 micrometer, 5 micrometers, 10 micrometers or 20 micrometers to about 2 mm, 1 mm, 0.5 mm, 250 micrometers, or 100 micrometers. The fiber desirably is an inorganic fiber such as those known in the art. Illustratively, the inorganic fiber may be any E, A, C, ECR, R, S, D or NE glass fibers such as those available from Owen-Corning.

When the reinforcement component is a particulate, the particulate may be any suitable particle such as those known in the art. Illustratively, the particulate may be a ceramic (crystalline or amorphous), metal or carbon particulate (e.g., carbon black, carbon nanotubes, graphite). It is understood that carbon means any carbon that has surface polar groups that may arise from exposure to the environment or impurities. Examples of particulates that may be suitable include inorganic particulates such as clay, talc, wollastonite, mica, coal ash, calcium carbonate, mono metal oxides (e.g., silica, calcium oxide, titania, alumina, zirconia, or magnesia) or mixed metal oxides (e.g., alumino silicates), nitrides (silicon nitride, aluminum nitride), carbides (e.g. silicon carbide or boron carbide) or any combination (e.g., oxy-carbide or oxy-nitride) or mixture thereof. The filler desirably is an organic filler that is comprised of cellulose derived from plant matter. For example, the filler may be wood flour from sawmill waste, recycled cellulosic fibers from paper products such as magazine, books, newspapers, corrugated boxes and the like. Illustratively, the filler may be a glass filler such as those available from Strategic Materials, Houston, TX 77094

The filler may be present in any useful amount to realize the desired properties, facilitate the ability to withstand the dye sublimation image formation conditions, or enable the adherence of the abutment layer 30 or image accepting layer 40. The amount of reinforcement component or filler may be from about 10%, 20%, 30%, 40%, 50% to about 80%, 70%, or 60% by weight of the composite. The filler may be uniformly distributed throughout the composite or vary within or on the composite. For example, the reinforcement component may be distributed on the surface such as fibrous fabric sheets and the like. Examples of such filler or reinforcement are further described in U.S. Pat. Nos. 3,230,995; 3,544,417; 5,462,623; 5,589,243; 5,798,160; 6,740,381; and 9,091,067 each incorporated herein by reference. If uniformly present, it is desirable for there to be a sufficient amount so that there is exposed filler surface at the surface of the composite to realize good adherence of the image accepting layer 40 or abutment or abutting layer 30 to the composite. Illustratively, the composite 20, abutment layer 30, or accepting layer 40 may be comprised of a pultruded article having essentially long parallel fibers reinforcing the aforementioned such as described by U.S. Pat. Nos. 2,979,431; 4,549,920; 4,828,897; and 9,981,415.

The composite may be dense or a foam. A foam, as commonly understood in the art, means a body that is cellular. Cellular (foam) herein means the polymer body has a substantially lowered apparent density compared to the density of the polymer without any pores and the body is comprised of cells that are closed or open. Closed cell means that the gas within that cell is isolated from another cell by the polymer walls forming the cell. Open cell means that the gas in that cell is not so restricted and is able to flow to another cell without passing through any polymer cell walls to the atmosphere. The composite may entirely be a foam, but may be in many instances, a laminate structure (e.g., porous or foam core and dense skin or shell). The foam portion may be uniform or have one or more gradients of porosity. The skin may be any useful thickness. Generally, the skin or shell thickness or accepting layer 40 may be from about 10 micrometers, 100 micrometers or 500 micrometers to about 5 mm, 2 or 1 mm. The skin or shell may encapsulate any portion of the composite core that is a foam including encapsulating the entire composite foam core. Typically, the skin, when present covers at least 50%, 75% 90%, or essentially the entire surface of the foam core.

Desirably, the composite is essentially dense (e.g., at most about 10%, 5% or 1% porosity by volume).

The composite may be made by any suitable method of mixing and blending a thermoplastic polymer with a filler such as those known in the art such as casting, extrusion, injection molding and the like such as described by U.S. Pat. Nos. 3,888,810; 4,013,616; 5,851,469; 5,746,958; 6,117,924 7,041,716; 7,781,500; 8,709,586, US Pat. Appl. Nos. 2003/0021915; 2006/0068215; 2010/0021753; 2011/0071252; 2020/0199330 and Int. Pub. WO 2007/071732.

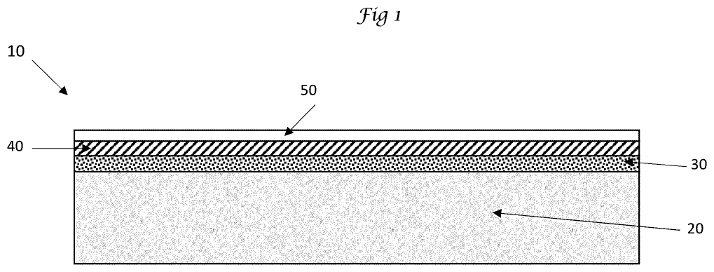

FIG. 1 is an illustration of one embodiment of the invention where the article 10 is comprised of a composite 20, abutment layer 30, image accepting layer 40 sandwiched between the abutment layer 30 and cap layer 50. The image accepting layer having therein the dye sublimation image in at least a portion of the thickness of said layer, which is further described below.

The composite has at least one layer adhered or integrally fused to a portion or all of the composite's surface, for example, to facilitate the formation of the dye sublimation image (e.g., image accepting layer 40), provide a base color coat, or provide some other property (e.g., smooth the surface of open cells on the surface of a foam composite surface). The image accepting layer 40 may be any layer that adheres or integrally fuses with the composite and may be a thermoplastic or thermoset polymer. In an example, the image accepting layer 40 or abutment layer 30 adheres to the filler material having polar groups at the surface of the composite allowing for sufficient ionic attraction to bond such layers sufficiently to prevent spalling or removal when subjected to environmental and wear conditions in use (e.g., decking planks). In another example, the image accepting layer or abutment layer may be fused with the thermoplastic of the composite (e.g., a maleic anhydride grafted polyethylene layer fused with the composite's polyethylene, polypropylene or copolymer thereof).

The accepting layer may include any films, coating or layers suitable for accepting and forming dye sublimation images such as those known in the art. Any suitable method of applying the accepting layer may be used such as those known in the art and may include, for example, thermoforming, coextrusion, brushing, doctor blading, spraying, laminating, or plating. Generally, such coatings or layers may include a thermoset or thermoplastic polymer having one or more polar groups such as a condensation polymer. Exemplary coatings or layers include polyurethane (e.g., oil or water dispersed dispersions of polyurethane, polyurea or polyisocyanurate particulates that coalesce upon removal of the liquid dispersion medium forming a somewhat uniform pore free coating), epoxies, acrylics/acrylates, alkyds, phenolics, polyamine, polyamide, fluoropolymers, polyvinylfluoride, polybutylene terephthalate, polyesters, polycarbonates, polystyrene and polystyrene copolymers (ABS, “acrylonitrile butadiene styrene” and the like) mixtures or combinations thereof. The image accepting layer may be smooth or have intentional embossing or waviness imparted thereto for aesthetics or to improve traction such as on a deck surface.

Examples of polymers useful for the image accepting layer 40 may also include a two-part acrylic-aliphatic urethane coatings available under the trade name PITTHANE, HPC High Gloss Epoxy, PPG flooring concrete epoxy primer, each from PPG Industries. An example of a thermoplastic polymer that may be useful include an acrylic-polyvinylchloride copolymer available under the tradename KYDEX, available from SEKISU KYDEX, Holland MI, a polycarbonate under the trade name LEXAN and a polyetherimide under the trade name ULTEM from Sabic, Pittsfield, MA and polyamide available under the tradename NYLENE from Nylene Polymer Solutions, RILSAN from Arkema, and various grades from UBE America Inc., Livonia, MI. Other thermoplastic polymers that may be useful for the image accepting layer include, for example, polyamide, polyimide, polyamideimide, polyester, polyetherester, thermoplastic polyurethane, polyacrylate (e.g., polymethyl methacrylate), polyacrylic acid, functionalized polyolefin (e.g., maleic anhydride grafted polyethylene) or mixture or combination of any of the aforementioned.

The composite 20 may have an undercoat layer (abutment or abutting layer 30) that is sandwiched between the composite and image accepting layer that provides one or more desired properties such as thermal resistance to facilitate the formation of the dye sublimated image attached or integral to the composite (i.e., may act as a gradient layer that has gradient that facilitates the bonding to the composite and to the accepting layer). For example, the abutment layer may be any useful coating that is resistant to heat or that absorbs heat that may assist the formation of the dye sublimation image without distorting or degrading the properties of the composite. The high temperature resistant coating may be any suitable high temperature coating such as those known in the art and typically have a higher use temperature (e.g., melt or degrade at a temperature above that of the thermoplastic of the composite). Commonly these coatings have a high concentration of metal or inorganic particulates that provide for thermal resistance, heat insulation or heat absorption or may be a high temperature foam (e.g., inorganic siliceous foam). Examples of heat resistance coating that may be useful include those available from PPG under the tradenames PPG HI-TEMP, AMERCOAT, AMERLOCK, DIMETCOTE, PSX, and SIGMATHERM. These coatings, in some instances, may also be used as the layer that accepts the dye sublimation image as described above. The undercoat or abutment layer may be any useful thickness such as those thicknesses described for the image accepting layer 40.

The article 10 may have a cap layer 50 that is on top of the image accepting layer 40, which may be clear coat or have a matte finish. The clear or opaque coating may be smooth, textured or embossed. The texturing or embossing may be any desired such as wood grain, stone, tile, brick or other masonry motif and may be applied by any suitable method such as those known in the art and, for example, as described in U.S. Pat. Appl. No. 2006/0099394. The cap layer 50 may be any useful thickness such as described for the image accepting layer. Exemplary polymers that may be useful for such cap layers include those described above for the image accepting layer.

The composite 30 may be a foam. Said foam may have any amount of open or closed cells. Even so, the cells may be advantageously closed, for example, to provide for improved insulation such as for siding or rigidity. The amount of closed cells may vary from essentially zero to essentially all closed cells. Generally, the amount of closed cells is less than 95%, 90% 75%, to 5%, 10% or 25%. The amount of closed or cell size may be determined by ASTM D 2856.

The cell size may be any useful size to make the article 10 and may depend on the particular article and its use. Illustratively, the foam may be microcellular to a cell size on the order of millimeters or even larger. Desirably, the average cell size is at from about 1 micrometer, 10, micrometers, 100 micrometers, 250 micrometers, 500 micrometers to about 10 mm, 5 mm or 2 mm. The porosity may be any shape or morphology, such as elliptical or spherical. The shape desired may be induced by mechanical agitation such as shear to elongate the cells to realize anisotropic properties if desired. The average cell size may be determined as described in U.S. Pat. No. 5,912,729 and known image analysis techniques of micrographs of cross-sections of the foam, which may also be used to determine gradient structures.

The composite may be rigid or flexible, but generally it is desirable for the composite to be rigid under compression or flexure (e.g., some bending deflection of a 10 ft plank is acceptable, without essentially any compressive deformation when walking on the plank). Sufficiently rigid generally means that under the typical compressive pressures used to form a dye sublimation image the composite does not distort in the absence of heating. Desirably, the composite has an elastic modulus (i.e., modulus of elasticity) of at least about 5,000 psi, 10,000 psi, 50,000 psi, 100,000 psi, 200,000 psi to about 1,000,000 psi or 500,000 psi.

The particulate reinforcement component may be isotropic and/or anisotropic. The particulate reinforcement component may spherical or angular (such as that formed when comminuting a ceramic). The particulate reinforcement component may have an acicular morphology wherein the aspect ratio is at least 2 to 50, wherein the acicularity means herein that the morphology may be needlelike or platy. Needlelike meaning that there are two smaller equivalent dimensions (typically referred to as height and width) and one larger dimensions (typically the length or width). Platy meaning that there are two larger somewhat equivalent dimensions (typically width and length) and one smaller dimension (typically height). More preferably the aspect ratio is at least 3, 4 or 5 to 25, 20 or 15. The average aspect ratio is determined by micrographic techniques measuring the longest and shortest dimension of a random representative sample of the particles (e.g., 100 to 200 particles).

The filler when it is a particulate should be a useful size that is not too large (e.g., spans the smallest dimension of a desired article) and not too small that the desired effects on properties is not realized. In defining a useful size, the particle size and size distribution is given by the median size (D50), D10, D90 and a maximum size limitation. The size is the equivalent spherical diameter by volume as measured by a laser light scattering method (Rayleigh or Mie with Mie scattering being preferred) using dispersions of the solids in liquids at low solids loading. D10 is the size where 10% of the particles have a smaller size, D50 (median) is the size where 50% of the particles have a smaller size and D90 is the size where 90% of the particles have a smaller size by volume. The size of the particulates within the composite may also be determined by known micrographic techniques. Generally, The filler has an equivalent spherical diameter median (D50) particle size of 0.1 micrometer to 25 micrometers, D10 of 0.05 to 5 micrometers, D90 of 20 to 40 micrometers and essentially no particles greater than about 70 micrometers or even 50 micrometers and no particles smaller than about 0.01 micrometers. Desirably, the median is 5 to 10 micrometers, the D10 is 0.5 to 2 micrometers and the D90 is 20 to 30 micrometers. Likewise, the reinforcement particulates desirably have a specific surface area from 0.1 m²/g to 20 m²/g and preferably from 2 m²/g to 10 m²/g, which may be determined by known standard methods such as nitrogen absorption typically referred to as BET nitrogen absorption.

The dye sublimation image may penetrate through the entire thickness of the image accepting layer or some portion (e.g., at least about 1%, 10%, 50% or 90% to essentially the thickness of the image accepting layer 40).

Illustratively, the dye sublimation image may be formed by any suitable dye sublimation method such as those known in the art. In many instances, it has been discovered to realize desirable clarity of the image and avoid distortion the exposure time is such that the temperature of the image accepting layer is raised to a sufficient temperature, but the bulk temperature of the composite is not raised to a temperature where undesired distortion or degradation of the composite takes place.

The exposure time to the elevated exposing temperature may be any suitable for the particular composite. Generally, the time may be, for example, from 10 seconds, 30 seconds, or 1 minute to about 10 or 5 minutes. The atmosphere may be any useful atmosphere such as air, inert atmosphere at any useful pressure including atmospheric pressure or vacuum.

If separate layers are desired to be adhered or attached to the composite when forming the article, such layers may be attached or adhered to the composite by any suitable method. For example, the abutment layer 30 and image accepting layer 40 may be formed by laminating a film thereto, coated by brushing, spraying, doctor blading, silk screening and as described hereinabove, or the like. Illustratively, the layer may be formed by coating the composite with an emulsion, liquid polymer, or dispersion in one part or two parts (reactive coating) and cured on the composite. The curing may be effectuated by allowing the film to coalesce and form a contiguous film or allow a two-part system to react and cure into a layer on the composite. Once the layer has cured or liquid medium evaporated or removed, the composite may then be exposed to the sublimating temperature and the dye sublimation image imprinted by pressing a dye sublimation film or sheet (transfer sheet) onto a surface of the image accepting layer to imprint the dye sublimation image. The layer may be comprised of a filler as described above. In a particular embodiment, the composite may be an unfilled thermoplastic that has an integral layer comprised of filler (e.g., fiberglass sheet) that imparts the desired rigidity and ability to accept the dye sublimatable image.

The dye sublimation image may be formed by any suitable method or apparatus such as those known in the art. Examples include methods and apparatus described in Intl. Pat. Appl. No. WO2020210700, U.S. Pat. Nos. 4,059,471; 4,664,672; 5,580,410; 6,335,749; 6,814,831; 7,033,973; 8,182,903; 8,283,290; 8,308,891; 8,561,534; 8,562,777; 9,956,814; and 10,583,686, US Pat. Appl. Nos. 2002/148054; 2003/019213; and 2020/0346483, and Canadian Pat. No. 2,670,225, each incorporated herein by reference. The method may employ any suitable dye sublimation ink such as those known in the art. Examples of dye sublimation inks include those described in U.S. Pat. Nos. 3,508,492; 3,632,291; 3,703,143; 3,829,286; 3,877,964; 3,961,965; 4,121,897; 4,354,851; 4,587,155, EP Pat. No. 0098506, and Intl. Pat. Appl. WO2018208521 each incorporated herein by reference. Likewise, the transfer sheet may be any suitable transfer sheet such as those known in the art and as described in the references cited in this paragraph. Generally, paper transfer sheets as commonly used and may be employed.

The dye sublimating generally is performed at a dye sublimating temperature of about 100° C., 120° C., 150° C. or 170° C. to about 200° C., 225° C. or 250° C. for a dye sublimating time sufficient to migrate and be incorporated in the imaging accepting layer to the desired depth and may vary depending on the application (e.g., desired depth to realize a desired wear life). Typically, the dye sublimating time is from 30 seconds, 1 minute, 2 minutes or 5 minutes to about 10 minutes. The pressure may be any useful pressure to effectively transfer the image in the time and detail desired without distorting and compacting the composite. Generally, it is desirable for the pressure to be as minimal as possible and as uniformly applied to realize a uniform and consistent dye sublimated image in the layer attached or integral to the composite. The pressure may be applied uniaxially or isometrically. In an example the temperature may be applied by a hot press such as heated a roll press or heated uniaxial die press. The pressure may be applied by use of a vacuum press, which may be augmented by applying external gas pressure above atmospheric pressure. The pressure may be, for example, from about 1, 2, 5 psi to about 300, 150, 100, 50, 20, or 15 psi.

When making particular shapes such as large sheets such as mimicking 4′×8′ plywood boards, it may be desirable to separately form the dye sublimated image in the image accepting layer (e.g., sheet) by the dye sublimation methods described herein and then subsequently adhere this sheet to the composite substrate comprising a non-polar thermoplastic polymer and a filler having polar groups. The bonding may be by any suitable method of adhering two materials such as described herein including heating and pressing as described to form the DSP image described herein.

The method surprisingly may use a composite that are comprised of polyolefins or a chlorine containing polymer that melt well below (e.g., 5, 10 or 20° C. or more below) the temperature where the dye sublimating is performed. That is, Tₘ is below the dye sublimating temperature. Likewise, the non-polar thermoplastic may be amorphous displaying a T_{g} that is below the dye sublimating temperature by the same degree Tₘ is below the dye sublimating temperature.

The article of this invention may be used in any application wherein an aesthetically appealing article is desired that is exposed to weathering whether by abrasive wear, rain (e.g., acid rain) or exposure to electromagnetic radiation such as from the sun. Applications where the article of this invention is particularly useful include those traditionally employing natural wood. For example, the article may be a board, siding shingle, door, decking, roofing shingle, fence post, railing, balustrade, paneling, furniture, fascia board, handle or frame.

### ILLUSTRATIVE EMBODIMENTS

The following examples are provided to illustrate the articles and methods to form them but are not intended to limit the scope thereof. All parts and percentages are by weight unless otherwise noted. Table 1 shows the ingredients used in the examples and comparative examples.

### Example 1

A one-inch-thick composite substrate (available from Envision Outdoor Living Products, Lamar, MO) comprised of about 50% wood flour and about 50% polyethylene by volume is sanded with 80 grit sandpaper. The surface of the sanded composite is brush coated with a two part polyurea coating available from ASTC Global, Santa Ana, CA, under the tradename ASTC Polymers. The coating is cured at room temperature for at least about 24 hours. A dye sublimated image is imparted to the polyurea layer by placing the composite in a hot press and dye sublimating using a paper transfer image printed using commercially available dye sublimating inks (Sawgrass, Charleston, SC). The composite is pressed at temperature of 200° C. (platen temperature) at a pressure of about 5 psi for about 1 minute. The image transfers with detail without smearing and the polyurea layer was well adhered to the composite.

### Comparative Example 1

A one-inch-thick substrate comprised of PVC (Versatex, Aliquippa, PA) without filler is coated and dye sublimated in the same fashion as Example 1. The polyurea coating fails to adhere well to the substrate and the substrate distorts during dye sublimating. The transferred image is indiscernible.

1. An article comprised of a composite substrate comprising a non-polar thermoplastic polymer and a filler having polar groups, the filler comprising 5% to 90% by volume of the composite and the composite having a dye sublimation image in a layer adhered or integral to a surface of the composite.

2. The article of claim 1, wherein the non-polar composite is comprised of one of more of polyethylene, polypropylene, copolymer of ethylene and propylene, a copolymer of ethylene, propylene or combination thereof with an acid or anhydride containing monomer, polyvinyl chloride, or polyvinylidene.

3. (canceled)

4. The article of claim 1, wherein the filler is comprised of natural occurring material or derived from a natural occurring material.

5.-6. (canceled)

7. The article of claim 1, wherein the filler is comprised of wood fibers or flour.

8. (canceled)

9. The article of claim 1, wherein the filler is an organic, ceramic, metal or carbon fiber or particle.

10.-11. (canceled)

12. The article of claim 1, wherein the composite has an integral skin on at least a portion of the composite, and the layer having the dye sublimation image is the integral skin.

13.-15. (canceled)

16. The article of claim 1, wherein the composite has a layer adhered to the composite and said adhered layers is comprised of a different material than the composite, the different material being a ceramic, organic polymer, metal, or mixture or composite thereof; and the adhered layer is comprised of a plurality of layers of differing materials, the plurality of layers being comprised of a layer abutting the composite and an image accepting layer disposed upon said abutting layer.

17.-19. (canceled)

20. The article of claim 16, wherein the abutting layer is comprised of a ceramic, metal, organic polymer, mixture or composite thereof that is different than the non-polar thermoplastic polymer of the composite and said abutting layer has a higher melt or degradation temperature than the non-polar thermoplastic polymer of the composite.

21.-22. (canceled)

23. The article of claim 16, wherein the image accepting layer is the layer that has the dye sublimation image therein and an outer layer encapsulates at least a portion of the image accepting layer, and the accepting layer or outer layer having texturing that is in the form of wood grain, stone, brick or tile.

24.-30. (canceled)

31. The article of claim 16, wherein the different material is comprised of a film or coating arising from the coalescing or curing of organic polymer particles dispersed in a liquid medium deposited on the composite.

32.-35. (canceled)

36. The article of claim 23, wherein the dye sublimation image depth is about 10 micrometers to about 5 mm.

37. The article of claim 1, wherein the article has a bending strength of about 250 psi to 20,000 psi according to ASTM D143.

38. (canceled)

39. The article of claim 1, wherein the article is a board, decking, siding shingle, door, roofing shingle, fence post, railing, balustrade, paneling, furniture, fascia board, handle or frame.

40. (canceled)

41. A method of forming an article having a dye sublimation image thereon comprising,
(i) exposing a composite substrate comprising a non-polar thermoplastic polymer, a filler having polar groups, and a dye sublimation accepting layer thereon to a temperature above 100° C. to about 250° C. and,
(ii) pressing a dye sublimation film onto the composite substrate for a time to imprint the dye sublimation image into the accepting layer forming the article.

42. The method of claim 41, wherein the dye accepting layer is comprised of one or more of the following polymers: polyester, polyurethane, polyisocyanurate, polyurea, polyurea/polyurethane, phenol-formaldehyde, urea-formaldehyde, melamine, diallyl-phthalate, epoxy, epoxy-novolac, benzoxazine, polyimide, bismaleimide, cyanate ester, furan resin, silicone or mixture thereof.

43. The method of claim 41, wherein forming the article is performed under a pressure of at least about 1 psi, at a temperature above glass transition temperature of the non-polar thermoplastic polymer to 250° C., and an exposure time of 5 seconds to 30 minutes.

44.-50. (canceled)

51. The method of claim 41, wherein the polar groups of the filler are comprised of one of more of hydroxyl, carboxylic acid, ester, or ether groups;
the non-polar thermoplastic polymer has a crystallinity from 5% to 60%; and
the dye sublimation accepting layer is comprised of one or more of a thermoplastic polymer or thermoset polymer.

52.-53. (canceled)

54. The method of claim 51, wherein the thermoplastic polymer is comprised of one or more of a polyamide, polyimide, polyamideimide, polyester, polyetherester, thermoplastic polyurethane, polyacrylate, polyacrylic acid, polyamine, polyamide, fluoropolymers, polyvinylfluoride, polybutylene terephthalate, polyesters, polycarbonates, polystyrene and polystyrene copolymers acrylonitrile butadiene styrene or functionalized polyolefin.

55. The method of claim 51, wherein the thermoset polymer is one or more of polyurethane, polyurea, polyisocyanurate, epoxies, or acrylics/acrylates, alkyds, phenolics.

56.-61. (canceled)

62. The method of claim 41, wherein the composite is further comprised of a thermoplastic condensation polymer.

63.-72. (canceled)
